(19) United States
(12) Patent Application Publication
(10) Pub. No.: US 2006/0087793 A1
(43) Pub. Date: Apr. 27, 2006

(54) Methods adapted for use in semiconductor processing apparatus including electrostatic chuck

(76) Inventors: Taeg-Kon Kim, Wulsan Metropolitan City (KR); Jae-Sun Choi, Yongin-si (KR); Yoon-Sang Jung, Busan Metropolitan City (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/221,759

(22) Filed: Sep. 9, 2005

(30) Foreign Application Priority Data
Oct. 21, 2004 (KR) 2004-84582

(51) Int. Cl. H01T 23/00

(52) U.S. Cl. 361/234

(57) ABSTRACT

A method of controlling a plasma etching apparatus comprises loading a wafer into a chamber containing an electrostatic chuck, securing the wafer to the electrostatic chuck, performing a process on the wafer, removing the wafer from the electrostatic chuck, and unloading the wafer from the chamber. The wafer is secured to the electrostatic chuck by applying a high voltage to the electrostatic chuck. The wafer is removed from the electrostatic chuck by disconnecting the high voltage from the electrostatic chuck, applying radio frequency power to the chamber to generate a de-chucking plasma from a reaction gas in the chamber, and applying bias power to the electrostatic chuck to increase the energy of ions in the de-chucking plasma, thereby removing excess electrical charges from the wafer.

### BACKGROUND OF THE INVENTION

1. Field of the Invention

The invention relates generally to methods adapted for use in a semiconductor processing apparatus including an electrostatic chuck. More particularly, the invention relates to methods of transferring a wafer to and from an electrostatic chuck in a plasma etching apparatus.

A claim of priority is made to Korean Patent Application No. 2004-84582 filed Oct. 21, 2004, the disclosure of which is hereby incorporated by reference in its entirety.

2. Description of the Related Art

Semiconductor devices are typically manufactured through some form of etching. Etching is a subtractive process whereby portions of a material layer or layers are removed from a substrate to form patterns on the substrate. The portions of the material layer(s) are usually removed by dissolving them in liquid chemicals or by converting them into a gaseous compound. Etching techniques involving chemicals in liquid phase are collectively referred to as “wet etching” and etching techniques involving chemicals in gas phase are referred to as “dry etching”.

The portions of the material layer(s) to be etched are typically defined by forming a pattern on the material layer. For example, a photoresist pattern defining portions of the material layer to be etched may be formed on the material layer using a photolithography process. Etching processes are then carried out on the material layer(s) using the photoresist pattern as an etch mask.

In the past, wet etching was widely used to form integrated circuit devices. However currently, wet etching is rarely used because it is highly isotropic and therefore not well suited to the manufacture of highly integrated devices. Consequently, dry etching is more commonly used in modern semiconductor device manufacturing.

As mentioned above, dry etching involves the use of chemicals in gas phase. Dry etching can involve the use of chemical and/or physical processes to remove materials from a semiconductor. Examples of dry etching include, as examples, plasma etching and reactive ion etching (RIE).

A conventional apparatus for performing plasma etching typically includes an electrostatic chuck (ESC) installed in a processing chamber. The electrostatic chuck uses electrostatic force to hold a wafer in place while plasma etching processes are performed. The apparatus may further include a mechanical clamp for further securing the wafer during the plasma etching processes.

Plasma etching is generally performed by injecting a reaction gas into the processing chamber and applying radio frequency (RF) power to the chamber to create plasma from the reactive gas. The RF power is typically applied to either an upper electrode in the chamber or to the electrostatic chuck. In addition to the RF power, a bias power may be applied to the electrostatic chuck to control the energy of ions bombarding the material layer.

Unfortunately, a number of problems are commonly encountered when securing a wafer in the conventional plasma etching apparatus. For example, the mechanical clamp used to secure the wafer may expose the wafer to foreign substances, i.e., contaminants that may cause defects in the wafer. In addition, helium gas applied to the ESC to cool the wafer may cause the wafer to float over the ESC.

In order to address these problems, modern ESCs are often attached to high voltage modules providing about 400V to more securely fasten, or “chuck” the wafer to the electrostatic chuck during etching processes.

Once the etching processes are completed, a de-chucking operation is performed to discharge static electricity stored in the wafer and the ESC. The de-chucking operation is intended to release the wafer from the ESC. However, where the de-chucking operation is incompletely or incorrectly performed, the wafer may be damaged or displaced from its proper position due to popping or sticking when it is unloaded by a lift pin.

In a conventional plasma etching apparatus, the de-chucking operation comprises interrupting the voltage supplied by the high voltage module and applying about 400 W or RF power to the processing chamber to generate a de-chucking plasma therein. The de-chucking plasma causes charges on the surface of the wafer to be discharged into the chamber, thereby releasing the wafer from the electrostatic chuck.

Unfortunately, however, where the wafer has a high permittivity, the de-chucking operation is not entirely effective because the wafer will often retain enough charge to interfere with the transfer of the wafer from the electrostatic chuck. Wafers having high permittivity include, for example, those including oxide and/or nitride layers.

Wafers including a nitride layer are particularly problematic because the permittivity of a nitride layer is roughly 4.6 times higher than that of an oxide layer. Unfortunately, nitride layers are commonly found in many important semiconductor devices. For example, multi-layered insulating layers having an oxide-nitride-oxide (ONO) structure, such as SiO₂/Si₃N₄/SiO₂, are commonly used as a type of gate insulating layer to improve the charge holding capability of a memory device while scaling down the device. The capacitance of multi-layered insulating layers may cause the layers to retain even more charge, thus presenting even further problems for the de-chucking operation.

Because conventional de-chucking methods fail to completely remove electrical charges from wafers processed by a plasma etching apparatus, new de-chucking methods are needed to replace the conventional method.

### SUMMARY OF THE INVENTION

One embodiment of the invention provides a plasma processing method for use in a plasma processing apparatus capable of improving discharge efficiency by providing both RF source power and bias power when discharging an electrostatic chuck.

Another embodiment of the invention provides a plasma processing method, a de-chucking method for use in a plasma processing apparatus, and a method of controlling a plasma etching apparatus. The diversity of the embodiments indicates that the present invention can be adapted to various processing apparatuses using plasma.

In one aspect, the invention is directed to a plasma processing method. The plasma processing method includes: performing a predetermined process on a wafer seated on an electrostatic chuck in a chamber of a plasma processing apparatus by applying RF source power; de-chucking the wafer from the electrostatic chuck by supplying a predetermined RF source power to generate de-chucking plasma, and a predetermined bias power to increase ion energy on the wafer to discharge charges on the wafer into the chamber; and lifting the wafer using a lift pin installed at the electrostatic chuck and unloading the lifted substrate to a transfer robot.

In addition, in de-chucking the wafer, the predetermined RF source power may be about 400 W, and the predetermined bias power may be about 20˜100 W Further, in the predetermined process, a voltage of about 400 V may be applied to the electrostatic chuck, and in de-chucking the wafer, a reaction gas may include one of argon gas and nitrogen gas.

In another aspect, the invention is directed to a de-chucking method for use in a plasma processing apparatus. The de-chucking method includes: supplying a predetermined reaction gas into a chamber of a processing apparatus where a predetermined process is performed on a wafer; supplying a predetermined RF source power to generate de-chucking plasma for discharging charges on the wafer to the chamber of the processing apparatus; and supplying a predetermined bias power to increase ion energy on the wafer.

In addition, the predetermined RF source power may be about 400 W, and the predetermined bias power may be about 20˜100 W. Further, the reaction gas may include one of argon gas and nitrogen gas.

In still another aspect, the invention is directed to a method of controlling a plasma etching apparatus. The method includes: loading a wafer into a chamber of a processing apparatus using a transfer robot and seating the wafer on an electrostatic chuck located in the chamber; chucking the wafer on the electrostatic chuck using electrostatic power; etching a predetermined material layer of the wafer chucked on the electrostatic chuck using plasma by applying RF source power and bias power; de-chucking the wafer from the electrostatic chuck by supplying a predetermined RF source power to generate de-chucking plasma, and a predetermined bias power to increase ion energy on the wafer to discharge charges on the wafer to the chamber; and lifting the wafer using a lift pin installed at the electrostatic chuck and unloading the lifted substrate to a transfer apparatus.

In addition, in de-chucking the wafer, the predetermined RF source power may be about 400 W, and the predetermined bias power may be about 20˜100 W. Further, in etching the wafer, a voltage of about 400 V may be applied to the electrostatic chuck, and in de-chucking the wafer, a reaction gas may include one of argon gas and nitrogen gas.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

Figure FIG. 1 is a diagram of a plasma etching apparatus employing a plasma etching method in accordance with an embodiment of the present invention;

FIG. 2 is a flowchart illustrating a method of controlling a plasma etching apparatus in accordance an embodiment of the present invention;

FIG. 3 is a flowchart illustrating a method of controlling a plasma etching apparatus in accordance with another embodiment of the present invention; and,

FIG. 4 is a flowchart illustrating a method of de-chucking a wafer from an electrostatic chuck in accordance with an embodiment of the present invention.

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

Methods of controlling a semiconductor manufacturing apparatus in accordance embodiments of the present invention are described below with reference to a plasma etching apparatus shown in FIG. 1. The plasma etching apparatus of FIG. 1 is an inductively coupled plasma (ICP) etching apparatus, however the methods find ready application in other plasma etching apparatuses as well. Moreover, the methods also find application in other (non plasma etching) semiconductor manufacturing apparatuses using an ESC, such a chemical vapor deposition (CVD) apparatus.

Referring to FIG. 1, the plasma etching apparatus includes a chamber 10, a ceramic dome shaped cover 20 installed on the chamber, and a discharge switch 11 connected between the chamber and ground. The apparatus further comprises a plurality of inductive coils 21 wound on cover 20 and an RF power source 22 connected to inductive coils 21. The inside of chamber 10 is fluidly connected with a vacuum pump 70, and a reaction gas supply part 80 supplying a reaction gas chamber 10. Reaction gas supply part 80 is connected to one side of chamber 10.

An electrostatic chuck 30 is installed at a lower part of chamber 10. Electrostatic chuck 30 holds a wafer W in place using electrostatic power while a plasma etching process is performed. A helium gas supply part 60 supplies helium gas to the wafer to cool it during processing. Helium gas supply part 60 is connected to a lower part of the electrostatic chuck to supply the helium gas to a bottom surface of wafer W.

A lift for loading and unloading the wafer on electrostatic chuck 30 is installed under electrostatic chuck 30. A lift pin 40 of the lift passes through electrostatic chuck 30 to contact a bottom surface of wafer W.

A bias power source 31 providing electrical power (i.e., a bias power) for the plasma etching process is connected to electrostatic chuck 30 and a high voltage module 50 generating a high voltage to secure wafer W on electrostatic chuck 30 during the plasma etching process is also connected to electrostatic chuck 30.

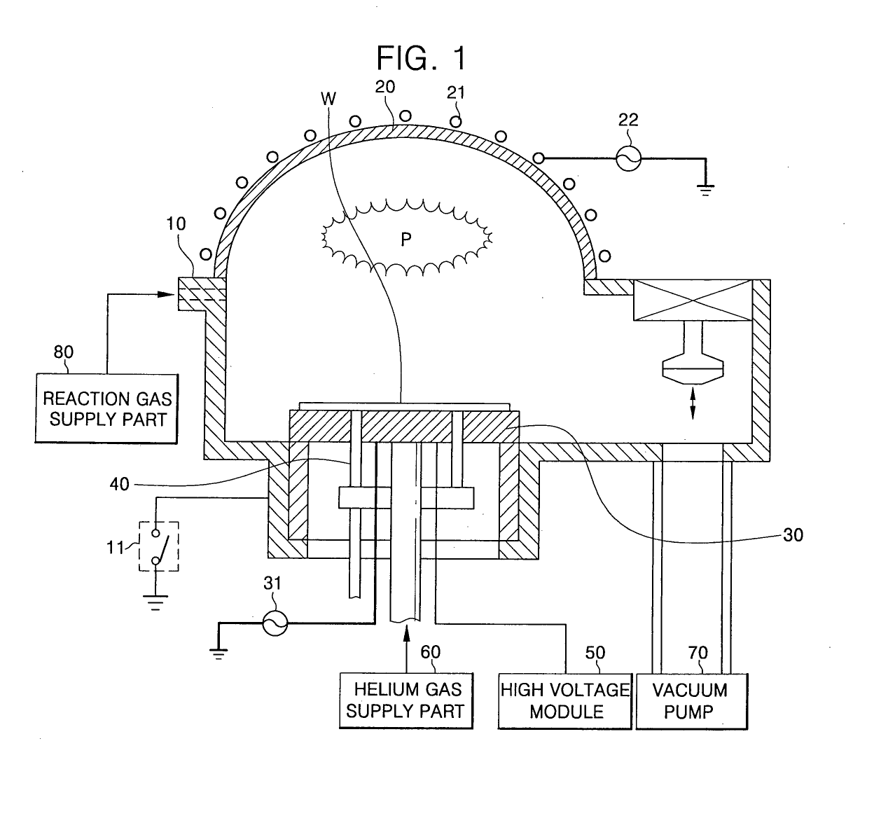

FIG. 2 is a flowchart illustrating a method of controlling the plasma etching apparatus shown in FIG. 1. In the description that follows, method steps are designated within parentheses (XXX) to distinguish them from exemplary elements, like those shown in FIG. 1.

Referring to FIG. 2, the method of controlling the plasma etching apparatus includes loading wafer W onto the plasma etching apparatus (S200), chucking the wafer (S210), etching wafer W (S220), de-chucking wafer W (S230), and unloading wafer W from the plasma etching apparatus (S240).

According to selected embodiments of the invention, loading wafer W onto the plasma etching apparatus (S210) comprises transferring wafer W onto electrostatic chuck 30 in chamber 10 using a transfer robot (not shown). The transfer robot places wafer W on lift pin 40 protruding from electrostatic chuck 30, and then lift pin 40 is lowered to place wafer W on electrostatic chuck 30.

A reaction gas is continuously supplied by reaction gas supply part 80 during the plasma etching process. The reaction gas generally uses Cl₂ and BCl₂, and the inside of chamber 10 is maintained at a low pressure of about 18 mtorr by vacuum pump 70.

Wafer W is typically chucked (S210) by applying a voltage of approximately 400V to electrostatic chuck 30 through high voltage module 50. A resulting electrostatic force on electrostatic chuck 30 causes wafer W to become secured to electrostatic chuck 30. Once wafer W is chucked, helium gas is supplied to electrostatic chuck 30 to cool wafer W.

Then, wafer W is etched (S220). Wafer W is generally etched by applying approximately 1600 W of RF power to inductive coils 21 through RF power source 22, and applying an electrical power of 220 W to electrostatic chuck 30 through bias power source 31. The RF power excites the reaction gas to form plasma used in the etching process. Wafer W is etched by selectively removing portions of a material layer from the wafer via a chemical reaction between ions in the plasma and the material layer.

After wafer W is etched (S220), it is then de-chucked (S230). Wafer W is de-chucked by first disconnecting high voltage module 50 from electrostatic chuck 30. RF power source 22 then generates approximately 400 W of RF power to create a de-chucking plasma “P” in chamber 10 from a de-chucking reaction gas. The de-chucking reaction gas typically comprises an argon gas or a nitrogen gas. At the same time, chamber 10 is converted to a discharge mode by closing discharge switch 11. In addition, vacuum pump 70 also performs a pumping operation while the de-chucking operation is being performed.

Bias power source 31 preferably supplies between 20 and 100 W of bias power to electrostatic chuck 30 at the same time that the RF power is supplied to the chamber. Bias power source 31 is generally required to supply at least 20 W of bias power to electrostatic chuck 30 in order to produce sufficient ion bombardment energy to completely de-chuck wafer W. However, where more than 100 W of bias power is supplied by bias power source 31, wafer W may be further etched by the de-chucking operation, which is generally undesirable.

Where bias power source 31 does not supply any bias power during the de-chucking operation, and hence only RF power is supplied to chamber 10, insufficient ion energy is supplied to completely de-chuck wafer W. As a result, where wafer W contains a material layer with high permittivity (e.g., a nitride layer), electrical charges on wafer W will not be sufficiently discharged to chamber 10. In other words, wafer W retains some charge even after the de-chucking operation is performed. On the other hand, where bias power source 31 supplies an adequate amount of electrical power to electrostatic chuck 30, charges on wafer W are effectively discharged to chamber 10.

After the de-chucking operation is performed, wafer W is unloaded from the plasma etching apparatus (S240). Unloading wafer W typically comprises lifting wafer W using lift pin 40 and transferring wafer W outside of chamber 10 using the transfer robot. The transfer robot generally transfers wafer W by entering chamber 10 and removing wafer W therefrom. The wafer may then be transferred to another chamber to undergo subsequent processing, for example. Once the wafer has been transferred from the chamber, the plasma etching process is complete.

The method of FIG. 2 finds application in various plasma processing apparatuses in addition to the plasma etching apparatus shown in FIG. 1. For example, the method finds application in a plasma enhanced chemical vapor deposition (PECVD) apparatus, a dry etching apparatus, and other plasma processing apparatuses. The substrate processed by the method may be used, for example, in a flat panel display or another device requiring micro-machining.

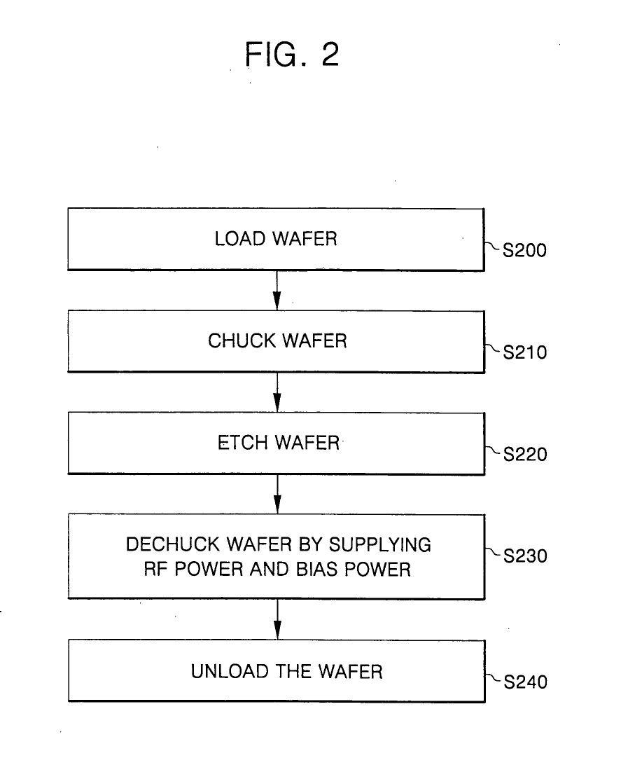

FIG. 3 is a flowchart illustrating a method of controlling a plasma processing apparatus in accordance with another embodiment of the present invention.

Referring to FIG. 3, high voltage module 50 is connected to electrostatic chuck 30 in the plasma processing apparatus. High voltage module 50 supplies a voltage of 400V to electrostatic chuck 30 to secure wafer W while a process such as an etching process is performed (S300). Once the process is completed, a reaction gas such as nitrogen or argon is supplied to chamber 10 by reaction gas supply part 80 (S310).

Then, approximately 400 W of RF power is applied to chamber 10 by RF power source 22 to generate de-chucking plasma. Between 20 and 100 W of electrical power is also supplied by bias power source 31 to electrostatic chuck 30 to increase the energy of ions in the de-chucking plasma so that the ions will discharge charges from the wafer and into the chamber, thereby de-chucking the substrate from electrostatic chuck 30 (S320).

Wafer W is then lifted from electrostatic chuck 30 using a lift pin or another similar apparatus installed by electrostatic chuck 30, and wafer W is unloaded using a transfer robot (S330).

Various modifications to the de-chucking method can be made based on the types of material layers contained in wafer W. For example, where a relatively low permittivity oxide layer is etched, the de-chucking operation may be performed without applying the bias power to electrostatic chuck 30. On the other hand, where a high permittivity material layer such as an ONO structure is etched, a bias power of about 20 to 100 W is applied in the de-chucking process. The de-chucking method described above can also be employed on wafers containing other types of high permittivity material layers.

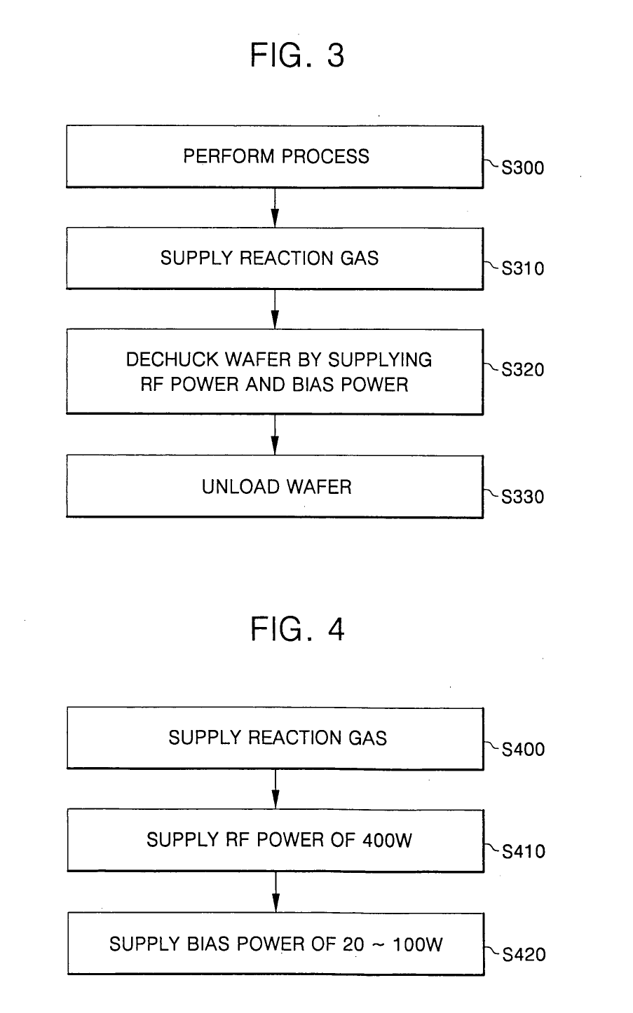

FIG. 4 is a flowchart illustrating a de-chucking method adapted for use in a in a plasma etching apparatus in accordance another embodiment of the present invention.

Referring to FIG. 4, the method comprises supplying a reaction gas into a chamber of a plasma etching apparatus and performing an etching process on a wafer located on an electrostatic chuck contained in the chamber (S400). The reaction gas typically comprises an argon gas or a nitrogen gas.

The method further comprises supplying approximately 400 W of RF power to the chamber using an RF power source (S410). The RF power generates a de-chucking plasma “P” from a reaction gas supplied to the chamber, which causes electrical charges to be discharged from the wafer.

The method further comprises applying a bias power of 20 to 100 W to the electrostatic chuck using a bias power source, thereby increasing the energy of ions in the de-chucking plasma (S420).

The method of de-chucking the wafer in the plasma etching apparatus can be applied to the manufacture of flat panel displays or other devices formed by micro-machining processes. In addition, the method can also be applied in various other semiconductor manufacturing processes requiring a de-chucking operation.

As can be understood from the foregoing description, methods adapted for use in a plasma etching apparatus according to embodiments of the present invention allow improved de-chucking of a wafer from an electrostatic chuck by providing both RF power and bias power to discharging the electrostatic chuck and the wafer. The RF power creates a de-chucking plasma and the bias power increases ion bombardment energy in the chamber to cause charges to leave the wafer. By effectively discharging the wafer, the wafer is prevented from being damaged or displaced due to sticking and popping when the lift pin is operated.

The foregoing preferred embodiments are teaching examples. Those of ordinary skill in the art will understand that various changes in form and details may be made to the exemplary embodiments without departing from the scope of the present invention which is defined by the following claims.

What is claimed:

1. A method adapted for use in a semiconductor processing apparatus comprising a processing chamber having an electrostatic chuck installed therein, the method comprising:
performing a process on a wafer located on the electrostatic chuck, the process comprising applying radio frequency (RF) power within the chamber;
performing a de-chucking operation on the wafer, the de-chucking operation comprising:
applying RF power within the chamber, thereby generating a de-chucking plasma of ions from a reaction gas in the chamber; and,
applying a bias power to the electrostatic chuck to increase energy of the ions;
lifting the wafer from the electrostatic chuck using a lift pin installed in the electrostatic chuck; and
removing the wafer from the lift pin using a transfer robot.

2. The method of claim 1, wherein the RF power is applied within the chamber at a level of about 400 W.

3. The method of claim 1, wherein the bias power is applied to the electrostatic chuck at a level of about 20 to 100 W.

4. The method of claim 1, wherein the process performed on the wafer is a plasma etching process.

5. The method of claim 1, wherein the wafer comprises a nitride layer.

6. The method of claim 1, wherein a voltage of about 400V is applied to the electrostatic chuck during the process performed on the wafer.

7. The plasma processing method according to claim 1, wherein the reaction gas includes at least one of argon gas and nitrogen gas.

8. A method adapted for use in a plasma etching apparatus comprising a chamber having an electrostatic chuck installed therein, the method comprising:
performing a de-chucking operation on a wafer located on the electrostatic chuck, the de-chucking operation comprising:
supplying a reaction gas to the chamber;
applying RF power within the chamber to generate a de-chucking plasma of ions from the reaction gas; and,
applying bias power to the electrostatic chuck to increase energy of the ions.

9. The method of claim 8, wherein the RF power is applied within the chamber at a level of about 400 W.

10. The method of claim 8, wherein the bias power is applied to the electrostatic chuck at a level of about 20 to 100 W.

11. The method of claim 8, wherein the reaction gas includes at least one of argon gas and nitrogen gas.

12. The method of claim 8, wherein the wafer comprises a nitride layer.

13. A method adapted for use in a plasma etching apparatus comprising a chamber having an electrostatic chuck installed therein, the method comprising:
loading a wafer into the chamber by placing the wafer on the electrostatic chuck using a transfer robot;
securing the wafer to the electrostatic chuck by applying electrostatic power to the electrostatic chuck;
performing a plasma etching process on a material layer of the wafer, the plasma etching process comprising:
supplying a first reaction gas to the chamber;
applying RF power within the chamber; and,
applying bias power to the electrostatic chuck;
performing a de-chucking operation on the wafer, the de-chucking operation comprising:
supplying a second reaction gas to the chamber;
applying radio frequency (RF) power within the chamber to generate a de-chucking plasma of ions in the chamber from the second reaction gas;
applying bias power to the electrostatic chuck to increase the energy of the ions in the de-chucking plasma;
lifting the wafer from the electrostatic chuck using a lift pin installed in the electrostatic chuck; and,
removing the wafer from the lift pin using a transfer robot.

14. The method of claim 13, wherein the RF power is applied within the chamber at a level of about 400 W.

15. The method of claim 13, wherein the bias power is applied to the electrostatic chuck at a level of about 20 to 100 W.

16. The method of claim 13, wherein the material layer of the wafer is a nitride layer.

17. The method of claim 13, further comprising:
applying a voltage of about 400V to the electrostatic chuck while the plasma etching process is performed on the material layer.

18. The method of claim 17, wherein performing the de-chucking operation on the wafer further comprises:
disconnecting the voltage of about 400V from the electrostatic chuck.

19. The method of claim 13, wherein the reaction gas includes at least one of argon gas and nitrogen gas.

20. The method of claim 13, wherein the plasma etching apparatus is an inductively coupled plasma (ICP) etching apparatus.
